(19) United States
(12) Patent Application Publication
(10) Pub. No.: US 2020/0376821 A1
(43) Pub. Date: Dec. 3, 2020

(54) COMPOSITE FILM, METHOD FOR FABRICATING THE SAME AND APPLICATIONS THEREOF

(71) Applicants: INDUSTRIAL TECHNOLOGY RESEARCH INSTITUTE, Hsinchu (TW); National Tsing Hua University, Hsinchu (TW)

(72) Inventors: Chih-Hung LEE, Taipei City (TW); Yen-Cheng LI, Hsinchu City (TW); Chi-Chang HU, Hsinchu City (TW); Cheng-Ta HSIEH, Kaohsiung City (TW)

(73) Assignees: INDUSTRIAL TECHNOLOGY RESEARCH INSTITUTE, Hsinchu (TW); National Tsing Hua University, Hsinchu (TW)

(21) Appl. No.: 16/886,389

(22) Filed: May 28, 2020

Related U.S. Application Data
(60) Provisional application No. 62/854,362, filed on May 30, 2019.

(30) Foreign Application Priority Data
Dec. 30, 2019 (TW) 108148347

(51) Int. Cl. B32B 27/12; D04H 1/728; H01M 2/16; D04H 1/4291; D04H 1/435

(52) U.S. Cl. CPC B32B 27/12; D04H 1/728; D04H 1/435; D04H 1/4291; H01M 2/162

(57) ABSTRACT

A composite film includes a fiber structure layer and a filling material layer. The fiber structure layer has a plurality of fibers and a first melting temperature. The filling material layer is disposed on the fiber structure layer and has a second melting temperature. At least one of the fibers extends into the filling material layer, and the first melting temperature is greater than the second melting temperature. Wherein the fiber structure layer includes a polymer selected from a group consisting of PI, polyurethanes (PU), polyamide, polybenzimidazole, polycarbonate, polyacrylonitrile, polyethyleneterephtalate, poly(vinylidenefluoride), poly(4-methylpentene) (TPX), and the arbitrary combinations thereof; the filling material layer includes polyolefin or polyester.

This application claims the benefit of U.S. provisional application Ser. No. 62/854,362, filed May 30, 2019, and Taiwan application Serial No. 108148347, filed Dec. 30, 2019, the subject matters of which are incorporated herein by references.

### TECHNICAL FIELD

The disclosure relates in general to a composite film, a method for fabricating the same and applications thereof.

### BACKGROUND

Lithium-ion batteries have been widely used in consumer electronics (such as portable electronic devices) based on its properties of high energy density, high operating voltage, no memory effect, and low self-discharge rate. Recently, lithium-ion batteries further become the mainstream of electric vehicle batteries based on its high energy density that can meet the needs of automotive power. However, with the continuous increase of the energy density and capacity of the lithium-ion batteries, the risk of burning and explosion caused by abnormal exotherm of lithium-ion batteries has also greatly increased. How to ensure the safe operation of lithium-ion batteries has become one of the important issues in the industry.

A separator that is placed between the positive and negative electrodes of a lithium-ion battery is the key component for conducting ions and ensuring the safe operation of the lithium-ion battery by isolating the positive and negative electrodes. Insulating polymer porous materials (such as polyethylene, polypropylene, etc.), based on its chemical stability and price advantage, have been used for a long time to make the separators of the lithium-ion batteries. However, some of the polymer porous materials with a lower melting temperature may be liable to shrink rapidly due to the severe heat release from an abnormally operated lithium-ion battery, and thus cannot continuously isolate the positive and negative electrodes of the abnormal lithium-ion battery, so as to result in an explosion of the lithium-ion battery. Although, various parties have continuously proposed high-temperature-resistant lithium-ion battery separators, such as ceramic separators, polyethylene terephthalate (PET) nonwoven fabric separators, and polyimide (Pl) non-woven separators, etc., but these solutions are still very limited in improving the security of the lithium-ion battery.

Therefore, there is a need to provide a composite film, a method for fabricating the same and applications thereof for overcoming the shortcomings in prior art.

### SUMMARY

According to one embodiment, a composite film is disclosed, wherein the composite film includes a fiber structure layer and a filling material layer. The fiber structure layer has a plurality of fibers and a first melting temperature. The filling material layer is disposed on the fiber structure layer and has a second melting temperature. At least one of the fibers extends into the filling material layer, and the first melting temperature is greater than the second melting temperature. Wherein, the fiber structure layer includes a polymer selected from a group consisting of PI, polyurethanes (PU), polyamide, polybenzimidazole, polycarbonate, polyacrylonitrile, polyethyleneterephtalate, poly(vinylidenefluoride), poly(4-methylpentene) (TPX), and the arbitrary combinations thereof; and the filling material layer includes polyolefin or polyester.

According to another embodiment, a method for fabricating a composite film is disclosed, wherein the method includes steps as follows: Firstly, a fiber structure layer having a plurality of fibers and a first melting temperature is formed. A filling material layer having a second melting temperature is then formed on the fiber structure layer to make at least one of the fibers extending into the filling material layer, wherein the first melting temperature is greater than the second melting temperature.

According to yet another embodiment, a battery separator is disclosed, wherein the battery separator includes a fiber structure layer and a filling material layer. The fiber structure layer has a plurality of fibers and a first melting temperature. The filling material layer is disposed on the fiber structure layer and has a second melting temperature. At least one of the fibers extends into the filling material layer, and the first melting temperature is greater than the second melting temperature. Wherein the fiber structure layer includes a polymer selected from a group consisting of PI, PU, polyamide, polybenzimidazole, polycarbonate, polyacrylonitrile, polyethyleneterephtalate, poly(vinylidenefluoride), TPX, and the arbitrary combinations thereof; and the filling material layer includes polyolefin or polyester.

### BRIEF DESCRIPTION OF THE DRAWINGS

The present disclosure will become more fully understood from the detailed description given herein below and the accompanying drawings which are given by way of illustration only and thus are not limitative of the present disclosure and wherein:

FIG. 1 is a flow chart illustrating the processing steps for fabricating a composite film according to one embodiment of present disclosure;

FIG. 2A is a diagram illustrating a manufacturing apparatus for manufacturing a fiber structure layer according to one embodiment of present disclosure;

FIG. 2B is a microscopic image taken by a scanning electron microscope (SEM) illustrating the cross-sectional structure of the fiber structure layer that is made by the manufacturing apparatus as depicted in FIG. 2A according to one embodiment of the present disclosure;

FIG. 3A is a perspective view illustrating the structure of a composite film according to one embodiment of the present disclosure;

FIG. 3B is a microscopic image taken by a SEM illustrating the cross-sectional structure of the composite film as depicted in FIG. 3A;

FIG. 4 is a perspective view illustrating the structure of a composite film according to another embodiment of the present disclosure;

FIG. 5 is a microscopic image taken by a SEM illustrating a top-view of the composite film depicted in FIG. 3B operated at a temperature less than 100° C.;

FIG. 6A is a microscopic image taken by a SEM illustrating a top-view of the composite film depicted in FIG. 3B operated at 100° C.;

FIG. 6B is a microscopic image taken by a SEM illustrating a cross-sectional view of the composite film depicted in FIG. 6A; and

FIG. 7 is a graph showing the relationship between the temperature and the resistance of the composite film according to one embodiment of the present disclosure.

### DETAILED DESCRIPTION

The present disclosure provides a composite film, a method for fabricating the same and applications thereof to provide a composite film with high thermal shutdown function and thermal dimensional stability which can be used as a separator in a battery for improving the electrical efficiency and safety of the battery. In the following detailed description, for purposes of explanation, numerous specific details are set forth in order to provide a thorough understanding of the disclosed embodiments.

Although the present disclosure does not illustrate all possible embodiments, other embodiments not disclosed in the present disclosure are still applicable. Moreover, the dimension scales used in the accompanying drawings are not based on actual proportion of the product. Therefore, the specification and drawings are used for explaining and describing the embodiments only, but not used for limiting the scope of protection of the present disclosure. Furthermore, in the drawings of the embodiments, some elements are omitted so that some features can be clearly illustrated. Designations common to the accompanying drawings and embodiments are used to indicate identical or similar elements.

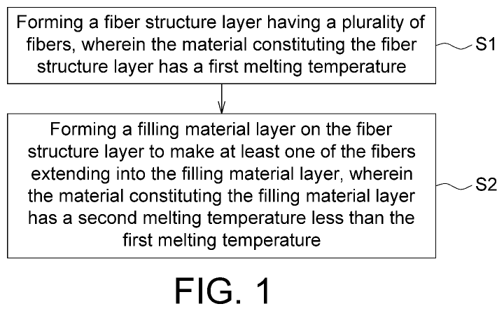

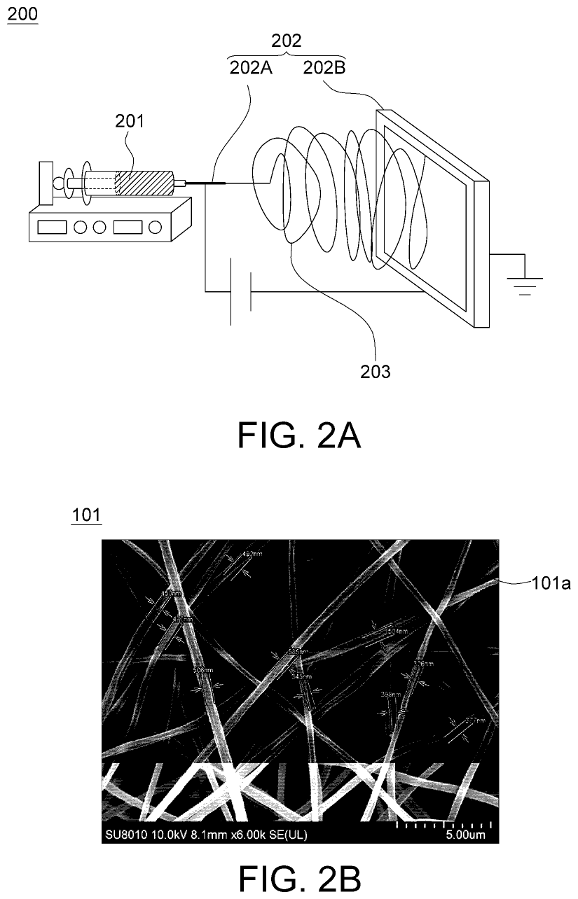

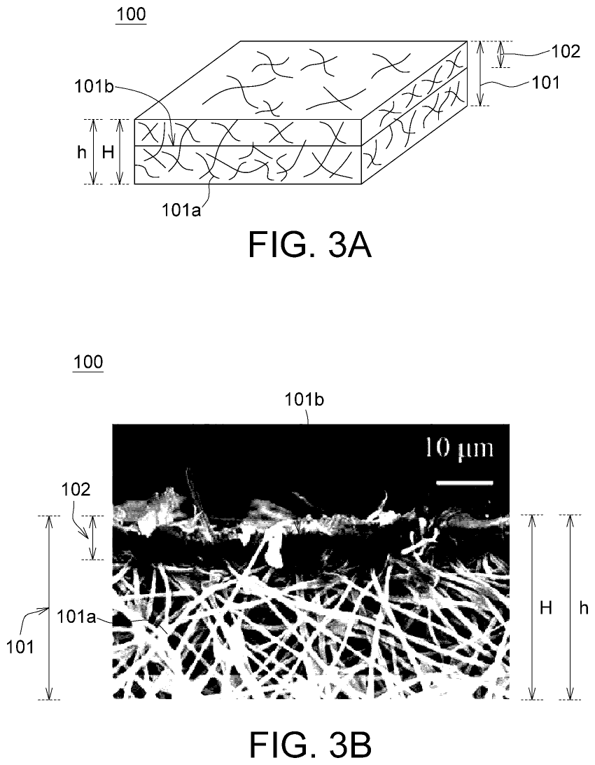

Please refer to FIG. 1. FIG. 1 is a flow chart illustrating the processing steps for fabricating a composite film 100 according to one embodiment of present disclosure (the designations indicating the elements of the composite film 100 during the processing steps can be found in the FIGS. 2B, 3A and 3B subsequently described). The method for fabricating the composite film 100 includes steps as follows: Firstly, a fiber structure layer 101 having a plurality of fibers 101a is formed, wherein the material used to constitute the fiber structure layer 101 may have a first melting temperature (see step S1). The first melting temperature may range from 200° C. to 400° C.

In some embodiments of the present disclosure, the fiber structure layer 101 may be formed by fixing at least one of fibers in an irregularly tangled or bonded manner. The material constituting the fiber structure layer 101 may be a polymer including, for example, PI, PU, polyamide, polybenzimidazole, polycarbonate, polyacrylonitrile, PET, polyvinylidene fluoride, TPX, or the arbitrary combinations thereof. In the present embodiment, the fiber structure layer 101 includes a PI non-woven fabric structure formed by an electrospinning process and including a plurality of fibers chemically or mechanically tangled or bonded with an average wire diameter ranging from 10 nanometers (nm) to 3 micrometers (μm) (e.g. ranging from 10 nm to 1 micrometer, or from 10 nm to 700 nm).

Referring to FIGS. 2A and 2B, FIG. 2A is a diagram illustrating a manufacturing apparatus 200 for manufacturing the fiber structure layer 101 according to one embodiment of present disclosure; and FIG. 2B is a microscopic image taken by a SEM illustrating the cross-sectional structure of the fiber structure layer 101 that is made by the manufacturing apparatus 200 as depicted in FIG. 2A according to one embodiment of the present disclosure. The forming of the fiber structure layer 101 includes steps as follows: a polyacrylic acid (PAA) solution 201 is prepared by using N,N-dimethylformamide (DMF) as a solvent, and the PAA solution 201 is applied with a voltage through an electrostatic spinning device 202 to make the PAA solution 201 divided into a plurality of droplets having static electricity. The droplets of the PAA solution 201 is accelerated by an electric field in the Taylor cone of a capillary, and the surface tension of the droplets is offset by the charge repulsive force on the droplets of the PAA solution 201, whereby a fine stream of the PAA solution 201 is erupted from a spinneret 202A of the manufacturing apparatus 200 to form a jet 203. The solvent of the PAA solution 201 can be evaporated; and the PAA solution 201 is solidified to form a fiber during the eruption. The charge movement in the jet 203 may be converted from charges moving around the surface of the droplets into a liner current flow moving along the surface of the fiber. The fiber may be continuously oscillated, stretched, and thinned by the electrostatic repulsion occurs at the bend corners thereof. Finally, the solidified fiber with a nanoscale diameter falls and stacks on a collector 202B of the manufacturing apparatus 200, and then subjected to an annealing step to form a fiber felt-bonded polyimide nonwoven fiber porous film.

In the present embodiment, the PAA solution 201 is formed by a polymerization using 4,4′oxydianiline and pyromellitic dianhydride as precursors. The PAA solution 201 may, in addition, include a spinnability enhancer, such as poly(vinylpyrrolidinone) having a molecular weight of 1,300,000, with a concentration of 10% to 20% by weight. Base on the contribution of the imine functional groups in polyimide, the fiber structure layer 101 formed of polyimide nonwoven fiber can have higher chemical and thermal stability as well as better electrolyte affinity. The polyimide nonwoven fibers used to constitute the fiber structure layer 101 may have an average diameter ranging from 10 nm to 700 nm and a tensile strength ranging from 30 MPa to 120 MPa.

The first melting temperature of the material constituting the fiber structure layer 101 may range from 200° C. to 350° C. For example, in present embodiment, after the fiber structure layer 101 is baked in a 150° C. oven for 30 minutes, the shrinkage rate of the fiber structure layer 101 is 0%; and the shrinkage rate of the fiber structure layer 101 may be less than 5% after being baked in an oven at 250° C. for 30 minutes. The overall temperature resistance of the fiber structure layer 101 (that is the operation temperature under which the shrinkage rate not exceeding 5%) can reach 350° C. It can indicate that the fiber structure layer 101 has excellent thermal stability and does not deform due to the high operation temperature.

Of noted that the structure and manufacturing method of the fiber structure layer 101 are not limited to this regard. In some embodiments of the present disclosure, the fiber structure layer 101 may be a fabric structure formed by fixing a plurality of fibers (not shown) in at least one regular arrangement bonding manner. For example, the fiber structure layer 101 may be a porous fabric structure layer (not shown) made by plain weaving (woven) or knitting. It can also be a composite structure layer (not shown) formed by entanglement or bonding of multiple layers of multi-porous woven structure layer, multi-porous non-woven structure layer, or a combination thereof through solvent, hot pressing, or other chemical or mechanical methods.

Referring to FIG. 1 again, a filling material layer 102 is then formed on the fiber structure layer 101 to make at least one of the fibers 101a in the fiber structure layer 101 extends into the filling material layer 102, wherein the material constituting the filling material layer 102 may have a second melting temperature lower than the first melting temperature (see step S2); meanwhile completing the preparation of the composite film 100. In some embodiments of the present disclosure, the filling material layer 102 may include a polyolefin material or a polyester material, and the second melting temperature of the material constituting the filling material layer 102 may range from 90° C. to 180° C. The polyolefin material may mainly include (but not limited to) polyethylene (PE), polypropylene (PP), polyoxyethylene (POE), or the arbitrary combinations thereof; and the polyester material may include ethylene-vinyl acetate (EVA) copolymer, methyl methacrylate (MMA) polymer, or the combination thereof.

In the present embodiment, a spin coating process may be used to apply a filling material solution (including a polyolefin material or a polyester material, such as a high density polyethylene (HDPE) solution or a low density polyethylene (LDPE) solution) coated on a surface 101b of the fiber structure layer 101; and the coated filling material solution is then dried to form the filling material layer 102. Referring to FIGS. 3A and 3B, FIG. 3A is a perspective view illustrating the structure of the composite film 100 according to one embodiment of the present description; and FIG. 3B is a microscopic image taken by a SEM illustrating the cross-sectional structure of the composite film 100 as depicted in FIG. 3A.

Since the HDPE solution or the LDPE solution applied on the surface 101b of the fiber structure layer 101 to form the filling material layer 102 may penetrate into the fiber structure layer 101 from the surface 101b thereof, thus the thickness of the fiber structure layer 101 may be partially occupied by the filling material layer 102 after the HDPE solution or the LDPE solution is dried. In other words, after forming the composite film 100, a plurality of fibers 101a of the fiber structure layer 101 may extend into the filling material layer 102, so that the filling material layer 102 and the fiber structure layer 101 may have a common upper surface. In some embodiments of the present disclosure, the plurality of fibers 101a of the fiber structure layer 101 may even pass through the upper surface of the dried filling material layer 102 (see FIG. 3B). Therefore, the overall thickness H of the composite film 100 may be substantially equal to the thickness h of the fibrous structure layer 101 (H=h), and it does not cause an increase in thickness due to the forming of the filling material layer 102, so as to provide a technical advantage of thinning of the composite film 100.

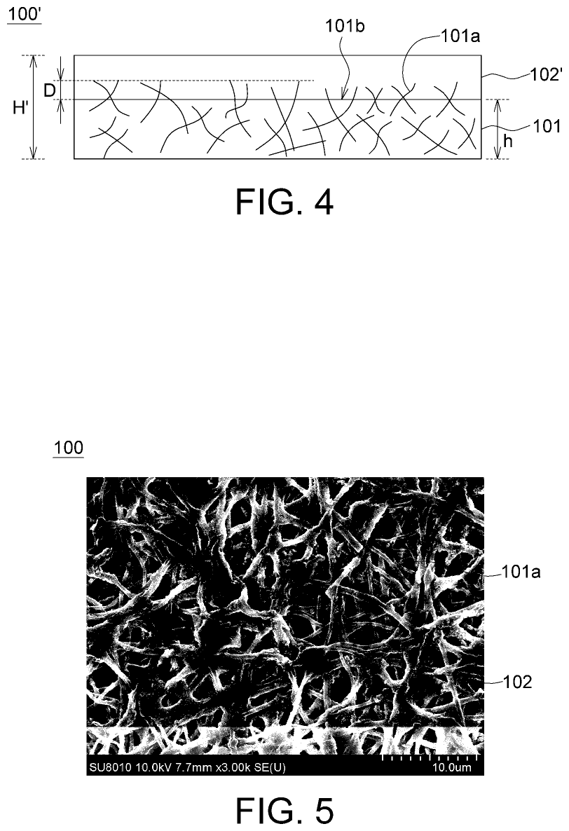

However, the structure of the composite film 100 is not limited to this regard. Referring to FIG. 4, FIG. 4 is a perspective view illustrating the structure of a composite film 100′ according to another embodiment of the present disclosure. In the present embodiment, because the HDPE solution or the LDPE solution applied on the surface 101b of the fiber structure layer 101 is too thick, only a part of the HDPE solution or the LDPE solution penetrates into the fiber structure layer 101, the filling material layer 102′ formed by the dried HDPE or LDPE solution does not have a common upper surface with the fiber structure layer 101 after the drying step is carried out. That is, the fibers 101a of the fiber structure layer 101 merely can extend into a portion of the filling material layer 102′ and not penetrate there through, such that the overall thickness H′ of the composite film 100′ is substantially larger than that (h) of the fiber structure layer 101 (H′>h). The ratio of the depth D of the fibers 101a extending into the filling material layer 102′ to the overall thickness H′ of the composite film 100′ may range from 5% to 50%.

Next, a plurality of functional tests can be performed on the composite film 100, for example, to observe or measure the surface morphology, porosity, pore-size distribution, electrolyte absorption rate, conductivity, thermal stability, and thermal pore-closing temperature of the composite film 100.

The porosity (P %) of the composite film 100 can be measured by a butyl alcohol (BuOH) immersion method and calculated by formula (1) as follows:

$$P ( \% ) = \frac{\frac{{M}_{BuOH}}{{ρ}_{BuOH}}}{\frac{{M}_{BuOH}}{{ρ}_{BuOH}} + \frac{{M}_{p}}{{ρ}_{p}}} \times 100 \% \qquad formula ( 1 )$$

Wherein, Mₚ and M_{BuOH} respectively represent the weight of the composite film 100 before and after soaking in BuOH for 2 hours; ρₚ and ρ_{BuOH} respectively represent the specific weights of the composite film 100 and BuOH.

The pore-size distribution of the composite film 100 can be measured using a capillary flow porometer.

The electrolyte absorption rate (EL, in %) of the composite film 100 can be measured by an electrolytic soaking method, and calculated by the following formula (2):

EL=(W₁−W₀)/W₀×100% formula (2)

Wherein, W₀ and W₁ respectively represent the weight of the composite film 100 before and after being immersed in the electrolyte for 2 hours. The electrolytic solution used in the electrolytic solution immersion method may be a lithium hexafluorophosphate (LiPF₆) salt dissolved in a carbonate mixed solvent system (ethylene carbonate (EC)/dimethyl carbonate (DMC)/ethyl methyl carbonate (EMC)=1/1/1, containing 1% vinylene carbonate (VC)) and having a concentration of 1M.

The conductivity of the composite film 100 can be measured using an electrochemical impedance spectroscopy (EIS) test including steps as follows: The composite film 100 is applied as a battery separator in a Swagelok simulation test battery cell to isolate two stainless steel electrodes thereof; and an alternating current with a frequency of 1 to 100 kHz and an amplitude of 10 mV is applied to the Swagelok simulation test cell to measure the electrical conductivity of the composite film 100. During the EIS test, an linear sweep voltammetry (LSV) is used to scan the current change between the two electrodes of the Swagelok simulation test battery cell at a scan rate of 50 mV/s, wherein the relative voltage between the two electrodes Li/Li+ may range from 3V to 5V; the scan can be performed cyclically; and the current change in the Swagelok simulation test battery cell can be record. The conductivity of the composite film 100 can be calculated by the following formula (3):

$$σ = \frac{d}{{R}_{b} S} \qquad formula ( 3 )$$

Wherein, σ, R_{b}, d, and S respectively represent the ion conductivity, the bulk resistance, the thickness and the area of the battery separator.

The thermal stability test of the composite film 100 is performed to check the size change of the composite film 100 at different operation temperatures. During the thermal stability test, the composite film 100 is put in the oven to bake for 1 hour at different operation temperatures which are set as intervals of every 10° C. between 110° C. and 150° C., and the size change of the composite film 100 can be measured after the baking performed at each of the operation temperatures.

The thermal pore-closing temperature of the composite film 100 can be measured in a battery charge/discharge testing system that has a lithium iron phosphate (LiFePO₄)/separator/mesophase carbon microbeads (MCMB) structure and a capacity of 138 mAh/g. A charge-discharge cycle is performed for 50 times at a discharge rate of 0.5C, within a charge-discharge voltage between 2.5 and 4.2V, wherein the charge rate ranges from 0.1 C to 1C. After the charge-discharge cycle, the separator is taken off from the battery, and clean with a carbonate solvent; a SEM is applied to check the integrity and the surface morphology of the separator, and an EIS test is performed to measure the conductivity (or resistance value) of the battery separator.

Referring to FIG. 5, FIG.5 is a microscopic image taken by a SEM illustrating a top-view of the composite film 100 depicted in FIG. 3B operated at a temperature less than 100° C. Since the second melting temperature of the material constituting the filling material layer 102 ranges from 90° C. to 180° C., which is much smaller than the first melting temperature (ranging from 200° C. to 400° C.) of the material constituting the fiber structure layer 101, thus the filling material layer 102 does not melt and fill the pores of the fiber structure layer 101 at an operation temperature of less than 100° C.

In the present embodiment, at an operation temperature lower than 100° C., the fiber structure layer 101 has an average pore diameter about 1370 nm, and the porosity thereof may be greater than 70%. After the filling material layer 102 is formed on the fiber structure layer 101 to form the composite film 100, the average pore diameter of the composite film 100 may range from 900 nm to 500 nm, and the porosity thereof is reduced about 20% (that is, the porosity of the composite film 100 is about 50%). However, in some other embodiments, after the filling material layer 102 is formed on the fiber structure layer 101 to form the composite film 100, the porosity of the composite film 100 may be from 40% to 65%. In addition, the variability of the pore-size distribution of the fiber structure layer 101 can be reduced, after the filling material layer 102 is formed. It can be indicated that after the composite film 100 is formed, the filling material layer 102 may not cause the pores of the fiber structure layer 101 to be severely blocked; and the presence of the filling material layer 102 can improve the uniformity of the pore diameter of the composite film 100 at the same time. When the composite film 100 is used in a lithium-ion battery serving as a separator, it can improve the uniformity of the current density, the battery electrical properties, and help suppress the dendrites growth of lithium deposits in the lithium-ion battery, thereby the safety of the lithium-ion battery can be significantly improved.

In addition, in the present embodiment, at an operation temperature of less than 100° C., the overall electrolyte absorption of the composite film 100 may be greater than 1200%, or even greater than 1300%, and the conductivity thereof can be about 4.3×10⁻⁴ S/cm. The overall electrical property is almost the same as a battery separator made of polyolefin material (without thermal pore-closing function), and is far superior to that of various commercially available battery separators. It can be indicated that, operated at a temperature less than 100° C., the composite film 100 provided by the embodiments of the present disclosure has a higher electrolyte absorption capacity and better ionic conductivity than that of various commercially available battery separators, and can improve the operation efficiency of the battery.

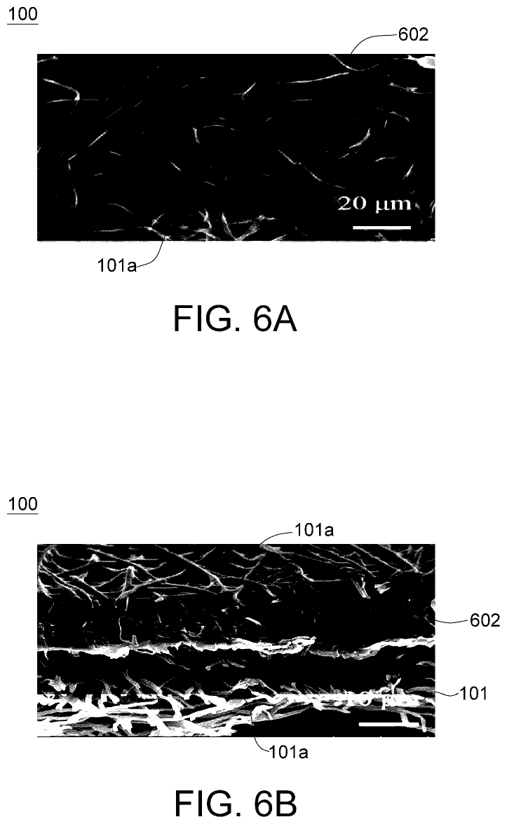

Referring to FIGS. 6A and 6B, FIG. 6A is a microscopic image taken by a SEM illustrating a top-view of the composite film 100 depicted in FIG. 3B operated at 100° C.; and FIG. 6B is a microscopic image taken by a SEM illustrating a cross-sectional view of the composite film 100 depicted in FIG. 6A. When the operation temperature is substantially greater than or equal to 100° C., the filling material layer 602 may be partially melted and aggregated, and the pores of the fiber structure layer 101 can be plugged by the melted material of the filling material layer 602, thereby the filling material layer 602 may provide a thermal pore-closing function to restrict the ions from passing through the composite film 100 serving as the separator of a battery, so as to effectively block the electrochemical reactions of the battery.

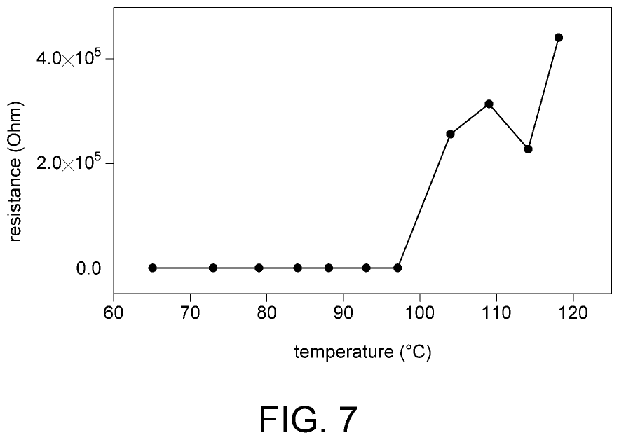

Referring to FIG. 7, FIG. 7 is a graph showing the relationship between the temperature and the resistance of the composite film 100 according to one embodiment of the present disclosure. In the present embodiment, when the operation temperature is lower than 100° C., the resistance value (the first resistance value) of the composite film 100 is about 10 ohms (Os). When the operation temperature is higher than 100° C., the resistance value (the second resistance value) of the composite film 100 increases to about 10⁵ Os. The second resistance value is about 10⁴ times of the first resistance value. It can be indicated that the composite film 100 can provide an excellent thermal shutdown function at a low operation temperature (that is below 160° C.).

It should be noted that the structure of the composite film 100 is not limited thereto. In some embodiments of the present disclosure, the composite film 100 may further include other suitable film structure, such as a ceramic film layer or a polymer film layer. The arranging sequence of the fiber structure layer 101, the filling material layer 102, and other film structures is not limited; and any composite film structure having the fiber structure layer 101 and the filler material layer 102 does not depart from the technical scope described in the disclosure. In addition, in the composite film 100, the types and amounts of materials constituting the fiber structure layer 101 and the filling material layer 102 can be adjusted according to different applications or functional requirements.

In the following description, a plurality of embodiments of the composite film 100 prepared with different materials and dosages are provided, and the above-mentioned functional tests are performed with a comparative embodiment using a conventional technology to verify the technical advantages of the composite film 100.

### EXAMPLE 1

A PAA solution was prepared using DMF as a solvent; and a film having a non-woven porous structure was formed by an electrospinning device 200 spraying the PAA solution under the conditions of a voltage of 24 kV and a spray distance of 25 cm. Subsequently, the film was heated at 300° C. for 2 hours for performing a high-temperature cyclization to form the polyimide fiber structure layer 101. Next, a LDPE solution with a concentration of 0.7 wt % was prepared using 2,6-dichlorotoluene as a solvent, and the LDPE solution was coated on one surface of the fiber structural layer 101 by a spin coating technique with a rotation speed of 2000 rpm to form a filling material layer 102, and the preparation of the composite film 100 was completed.

### EXAMPLES 2-3

The methods, conditions, and parameters for preparing the composite film 100 of Examples 2-3 wrere substantially identical to that for preparing the composite film 100 of Example 1. The main difference therebetween was the concentration of the LDPE solution used to form the filling material layer 102. In Example 2, the filling material layer 102 was formed using a LDPE solution having a concentration of 1.0 wt %. In Example 3, the filling material layer 102 was formed by using a LDPE solution having a concentration of 0.5 wt %.

### EXAMPLE 4

A PTX solution was prepared using cyclohexane as a solvent; and a film having a non-woven porous structure was formed by an electrospinning device 200 spraying the PTX solution under the conditions of a voltage of 24 kV and a spray distance of 25 cm to form the PTX fiber structure layer 101. Next, a LDPE solution with a concentration of 0.7 wt % was prepared using 2,6-dichlorotoluene as a solvent, and the LDPE solution was coated on one surface of the fiber structural layer 101 by a spin coating technique with a rotation speed of 2000 rpm to form a filling material layer 102, and the preparation of the composite film 100 was completed.

### COMPARATIVE EXAMPLE

The composite film provided by Comparative Example is a commercially available product (supplied by Celgard, USA), model of Celgard 2325, having a polypropylene/polyethylene/polypropylene (PP/PE/PP) three-layer structure with a total thickness of 25um.

The composite film 100 provided by Examples 1-4 together with the composite film provided by Comparative Example were used to make a plurality of battery separators; and the battery separators were then subjected to the aforementioned functional tests to verify the performance among the various battery separators made of the composite films provided by Examples 1-4 and the Comparative Example respectively. The test results are detailed in Table 1:

TABLE 1

| | | | | | Com- |
|---|---|---|---|---|---|
| | Example | Example | Example | Example | parative |
| | 1 | 2 | 3 | 4 | Example |
| Concentration of | 0.7 | 1 | 0.5 | 1 | — |
| LDPE | | | | | |
| Solution (wt %) | | | | | |
| Conductivity | 4.5 × | 3.3 × | 3.0 × | 8.5 × | 1.5 × |
| of the | 10⁻⁴ | 10⁻⁴ | 10⁻⁴ | 10⁻⁴ | 10⁻⁴ |
| Separator (S/cm) | | | | | |
| (Operation | | | | | |
| Temperature < | | | | | |
| 100° C.) | | | | | |
| Maximum | 350 | 350 | 350 | 240 | 160 |
| temperature | | | | | |
| resistance (° C.) | | | | | |
| Thermal | 100 | 100 | 100 | 100 | 130 |
| Pore-Closing | | | | | |
| Temperature (° C.) | | | | | |
| Shrinkage rate of | 0 | 0 | 0 | 2 | 90 |
| the Separator at | | | | | |
| 150° C. (%) | | | | | |

From the comparison results in Table 1, it can be seen that the insulation film made of the composite film 100 provided by Examples 1-4 has a conductivity higher than that of the composite film provided by Comparative Example under an operation temperature lower than 100° C.; and the composite film 100 has excellent thermal stability under the operation temperature of 150° C. The thermal pore-closing temperature of the separators made of the composite film 100 is 100° C., which is much lower than that (130° C.) of the composite film provided by Comparative Example. It can be indicated that the separators made of the composite film 100 provided by Examples 1-4 not only has an ion conductivity efficiency superior to that of the comparative example, but also has a more sensitive thermal shutdown function and excellent thermal dimensional stability when operated at a high temperature (which may be below about 150° C.).

In accordance with the above embodiments, a composite film, a method for fabricating the same and applications thereof are provided. A filling material layer having a lower melting temperature is provided above a fiber structure layer having a plurality of fibers to make at least one of the fibers in the fiber structure layer extending into the filling material layer, so as to form a composite film having higher porosity, higher electrolyte absorption capacity, and better ionic conductivity under an operation temperature less than 100° C., and can be used as a battery separator to help improving the operation efficiency of the battery.

When the operation temperature is increased greater than 100° C., the filling material layer can be partially melted to block the pores of the fiber structure layer based on the thermal characteristics of the filling material layer, whereby a thermal pore-closing effect for blocking the ions from passing through the separator to interrupt the battery operation is provided. As a result, the battery can be thermally shutdown to prevent the battery temperature from being further raised to trigger an explosion. At the same time, the fiber structure layer, based on its thermal properties of high melting temperature and high heat resistance, can ensure the separator having excellent thermal dimensional stability and not be deformed under a high operation temperature to provide the battery more reaction time for starting other safety mechanisms, so as to greatly improve the safety of battery operation.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A composite film comprising:
a fiber structure layer, having a plurality of fibers and a first melting temperature; and
a filling material layer, disposed on the fiber structure layer and has a second melting temperature; wherein at least one of the fibers extends into the filling material layer; the first melting temperature is greater than the second melting temperature; the fiber structure layer comprises a polymer selected from a group consisting of polyimide, polyurethane, polyamide, polybenzimidazole, polycarbonate, polyacrylonitrile, polyethyleneterephtalate, poly(vinylidenefluoride), poly(4-methylpentene), and the arbitrary combinations thereof; and the filling material layer comprises polyolefin or polyester.

2. The composite film according to claim 1, wherein the first melting temperature ranges from 200° C. to 400° C.; and the second melting temperature ranges from 90° C. to 180° C.

3. The composite film according to claim 1, wherein the composite film has a first resistance value under an operation temperature lower than 100° C. and a second resistance value under an operation temperature greater than or equal to 100° C.; and the second resistance value is about 10⁴ times of the first resistance value.

4. The composite film according to claim 1, wherein the fiber structure layer is a non-woven fabric structure layer; and the plurality of fibers have an average wire diameter ranging from 10 nanometers to 3 micrometers.

5. The composite film according to claim 1, wherein the at least one of the fibers extends into the filling material layer for a depth; and a ratio of the depth to a thickness of the composite film ranges from 5% to 50%.

6. The composite film according to claim 1, wherein the thickness of the composite film is equal to a thickness of the fiber structure layer.

7. The composite film according to claim 6, wherein the filling material layer and the fiber structure layer have a common upper surface.

8. A method for fabricating a composite film, comprising:
forming a fiber structure layer having a plurality of fibers and a first melting temperature; and
forming a filling material layer having a second melting temperature on the fiber structure layer to make at least one of the fibers extending into the filling material layer, wherein the first melting temperature is greater than the second melting temperature.

9. The method according to claim 8, wherein the fiber structure layer is formed by fixing at least one of the plurality of fibers in an irregularly tangled or bonded manner.

10. The method according to claim 8, wherein the forming of the filling material layer comprises coating a filling material solution on a surface of the fiber structure layer.

11. The method according to claim 8, wherein the forming of the fiber structure layer comprises a polymer electrospinning process; and the forming of the filling material solution comprises a spin coating process.

12. The method according to claim 11, prior to performing the polymer electrospinning process, further comprising preparing a polymer solution having a polymer selected from a group consisting of polyimide, polyurethane, polyam ide, polybenzim idazole, polycarbonate, polyacrylonitrile, polyethyleneterephtalate, poly(vinylidenefluoride), poly(4-methylpentene), and the arbitrary combinations thereof.

13. The method according to claim 11, wherein the filling material solution comprises polyolefin or polyester.

14. A battery separator comprising:
a fiber structure layer, having a plurality of fibers and a first melting temperature; and
a filling material layer, disposed on the fiber structure layer and has a second melting temperature; wherein at least one of the fibers extends into the filling material layer; the first melting temperature is greater than the second melting temperature; the fiber structure layer comprises a polymer selected from a group consisting of PI, PU, polyamide, polybenzimidazole, polycarbonate, polyacrylonitrile, polyethyleneterephtalate, poly(vinylidenefluoride), TPX, and the arbitrary combinations thereof; and the filling material layer comprises polyolefin or polyester.

15. The battery separator according to claim 14, wherein the first melting temperature ranges from 200° C. to 400° C.; and the second melting temperature ranges from 90° C. to 180° C.

16. The battery separator according to claim 14, wherein the separator has a first resistance value under an operation temperature lower than 100° C. and a second resistance value under an operation temperature greater than or equal to 100° C.; and the second resistance value is about 10⁴ times of the first resistance value.

17. The battery separator according to claim 14, wherein the fiber structure layer is a non-woven fabric structure layer; and the plurality of fibers have an average wire diameter ranging from 10 nm to 3 pm.

18. The battery separator according to claim 14, wherein the at least one of the fibers extends into the filling material layer for a depth; and a ratio of the depth to a thickness of the composite film ranges from 5% to 50%.

19. The battery separator according to claim 14, wherein the thickness of the composite film is equal to a thickness of the fiber structure layer.

20. The battery separator according to claim 19, wherein the filling material layer and the fiber structure layer have a common upper surface.
